(19) United States
(12) Patent Application Publication
(10) Pub. No.: US 2011/0246692 A1
(43) Pub. Date: Oct. 6, 2011

(54) Implementing Control Using A Single Path In A Multiple Path Interconnect System

(75) Inventors: Kenneth M. Valk, Rochester, MN (US); Bruce M. Walk, Rochester, MN (US)

(73) Assignee: INTERNATIONAL BUSINESS MACHINES CORPORATION, Armonk, NY (US)

(21) Appl. No.: 12/751,469

(22) Filed: Mar. 31, 2010

(51) Int. Cl. G06F 13/00

(52) U.S. Cl. 710/110; 710/107

(57) ABSTRACT

A method and circuit for implementing control using a single path in a multiple path interconnect system, and a design structure on which the subject circuit resides are provided. Control TL messages include control information to be transferred between a respective source transport layer of a source interconnect chip and a destination transport layer of a destination interconnect chip. Each transport layer (TL) includes a TL message port identifying a port used to send and receive control TL messages for a pair of source TL and destination TL. The respective TL message port of the pair of source TL and destination TL defines the single path used for control messages.

### FIELD OF THE INVENTION

The present invention relates generally to the data processing field, and more particularly, relates to a method and circuit for implementing control using a single path in a multiple path interconnect system to simplify control protocols and reduce overhead for control, and a design structure on which the subject circuit resides.

### DESCRIPTION OF THE RELATED ART

It is desirable to replace multiple interconnects, such as Ethernet, Peripheral Component Interconnect Express (PCIe), and Fibre channel, within a data center by providing one local rack interconnect system. When building an interconnect system or network it generally is an advantage to build the network interconnect system as a multiple path network interconnect system, where traffic from a particular source to a particular destination takes many paths through the network interconnect system, verses building the network interconnect system as a single-path, where all packets from a particular source to a particular destination all take the same path through the network interconnect system.

For protocols built on top of a network interconnect system, it is easier to design and implement these protocols if the underlying network interconnect system keeps traffic ordered, where packets from the same source to the same destination on the same virtual lane arrive in the same order in which they were sent. Unfortunately a multiple path network interconnect system is inherently unordered.

This packet ordering requirement in the multiple path interconnect system can be solved by adding a layer, called a Transport Layer (TL), to the interconnect system that places packets back in their original order before delivering those packets to the network user at the destination. The TL is responsible for creating an ordered network from the perspective of the network users, but the TL has control protocols of its own that would benefit from having an ordered network, for example, packet acknowledging, credit negotiation, connection management and the like.

Potential solutions to handle the unordered nature of the multiple path interconnect system are to make control protocols of the TL more complex or adding a large sequence-number or timestamp to control messages. A disadvantage of these solutions is that they either complicate the design increasing the design time and the risk of a design flaw or significantly increase the size of the control messages of the TL, which reduces efficiency of the interconnect system.

### SUMMARY OF THE INVENTION

Principal aspects of the present invention are to provide a method and circuit for implementing control using a single path in a multiple path interconnect system, and a design structure on which the subject circuit resides. Other important aspects of the present invention are to provide such method, circuitry, and design structure substantially without negative effect and that overcome many of the disadvantages of prior art arrangements.

In brief, a method and circuit for implementing control using a single path in a multiple path interconnect system, and a design structure on which the subject circuit resides are provided. Control TL messages include control information to be transferred between a respective transport layer of a source interconnect chip and a destination interconnect chip. Each transport layer (TL) includes a TL message port identifying a port to be used to send and receive control TL messages for a pair of source TL and destination TL. The pair of source TL and destination TL uses the single path that is defined by the respective TL message port.

In accordance with features of the invention, the TL message port identifying a port to be used to send and receive control TL messages for a pair of source TL and destination TL is changed when the TL message port is not a valid path or is not the shortest working path using a predefined protocol message sequence. The source TL or the destination TL having a lowest ID is selected as a master TL for the predefined protocol message sequence.

In accordance with features of the invention, the selected master TL selects a pending TL message port and sends control messages to the slave TL using the pending TL message port for changing to a new path for the control TL messages. The slave TL sends control acknowledgement messages using the pending TL message port to the master TL in the predefined protocol message sequence. When the predefined protocol message sequence is completed, the pending TL message port is set to the TL message port for the pair of source TL and destination TL.

### BRIEF DESCRIPTION OF THE DRAWINGS

The present invention together with the above and other objects and advantages may best be understood from the following detailed description of the preferred embodiments of the invention illustrated in the drawings, wherein:

FIGS. 1A, 1B, 1C, 1D, and 1E are respective schematic and block diagrams illustrating an exemplary a local rack interconnect system for implementing control using a single path in accordance with the preferred embodiment;

FIG. 2 is a schematic and block diagram illustrating a circuit for implementing control using a single path for control in accordance with the preferred embodiment;

FIGS. 3A, 3B, 4, and 5 are flow charts illustrating exemplary operations performed by the circuit of FIG. 2 for implementing control using a single path in accordance with the preferred embodiment; and

FIG. 6 is a flow diagram of a design process used in semiconductor design, manufacturing, and/or test.

### DETAILED DESCRIPTION OF THE PREFERRED EMBODIMENTS

In the following detailed description of embodiments of the invention, reference is made to the accompanying drawings, which illustrate example embodiments by which the invention may be practiced. It is to be understood that other embodiments may be utilized and structural changes may be made without departing from the scope of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In accordance with features of the invention, circuits and methods are provided for implementing control using a single path in a multiple path interconnect system.

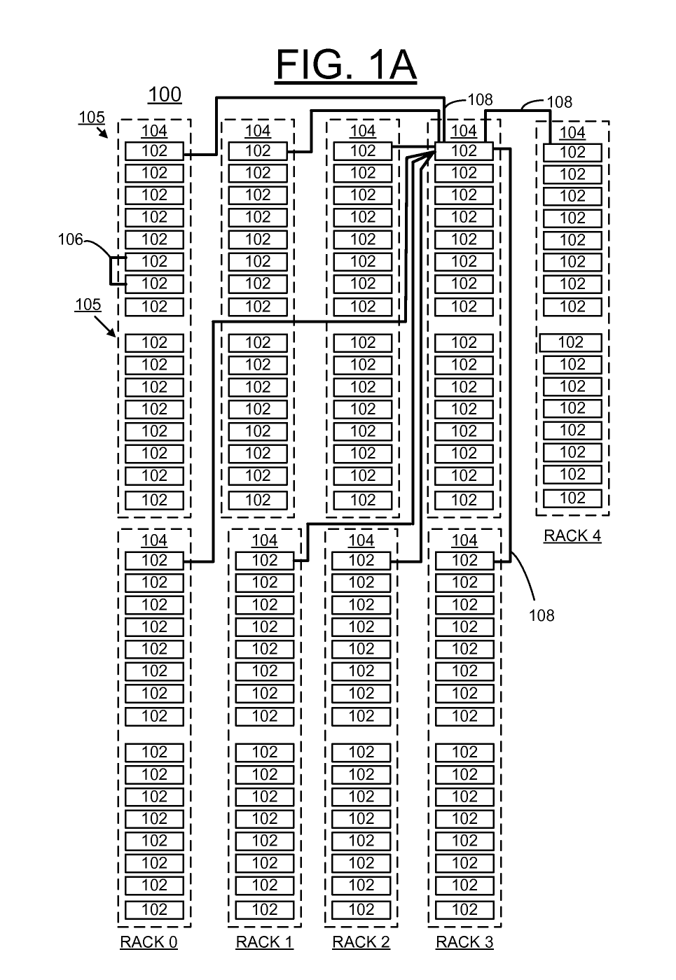

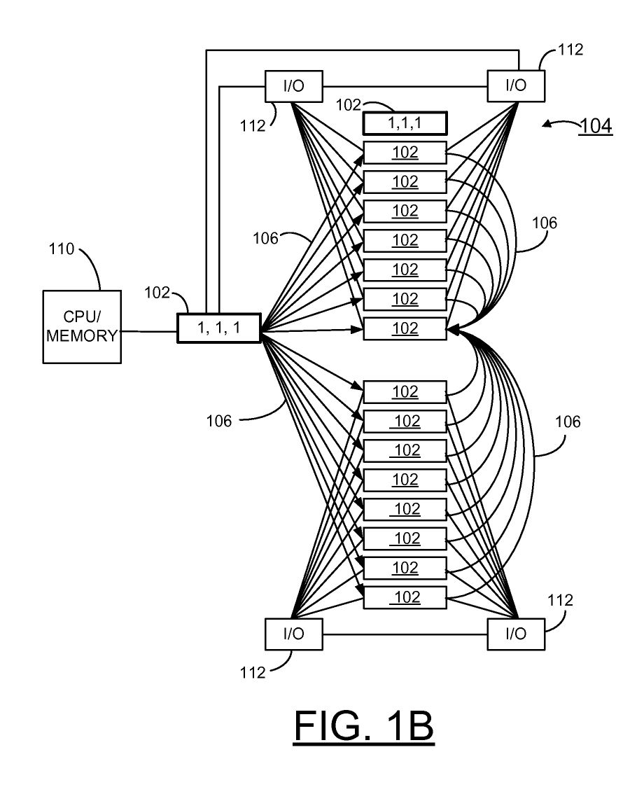

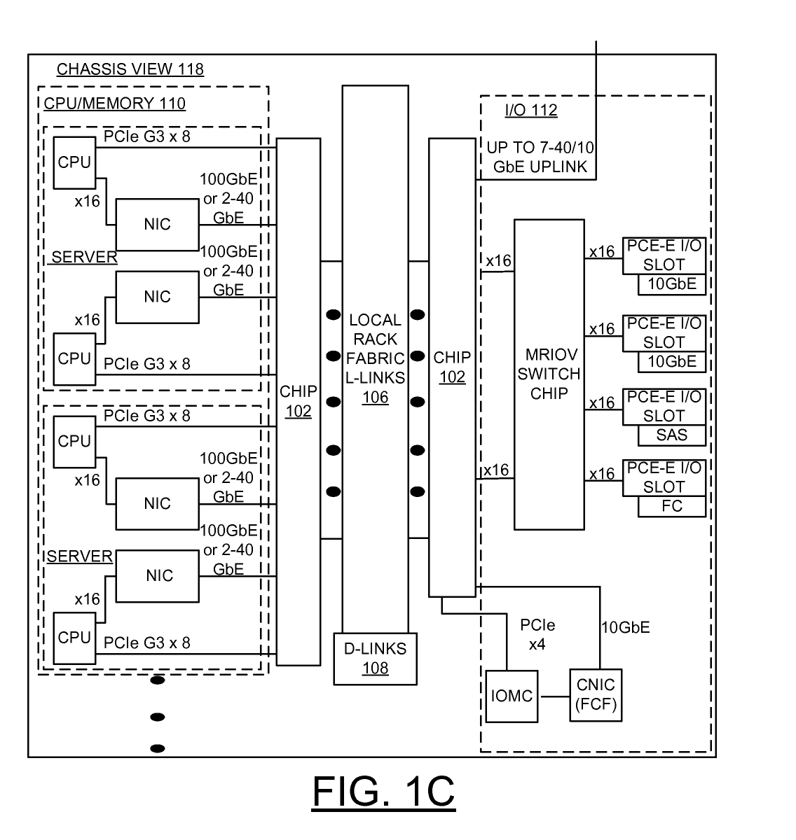

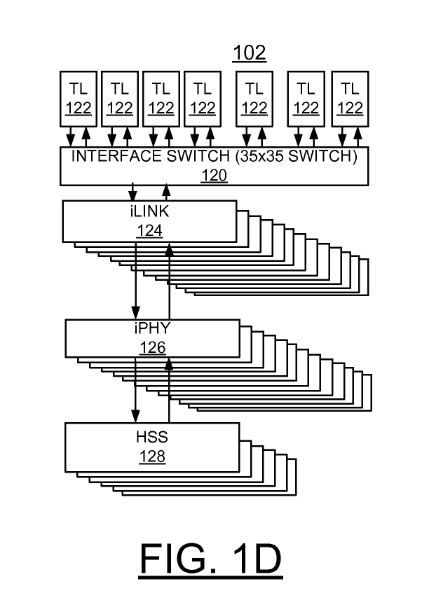

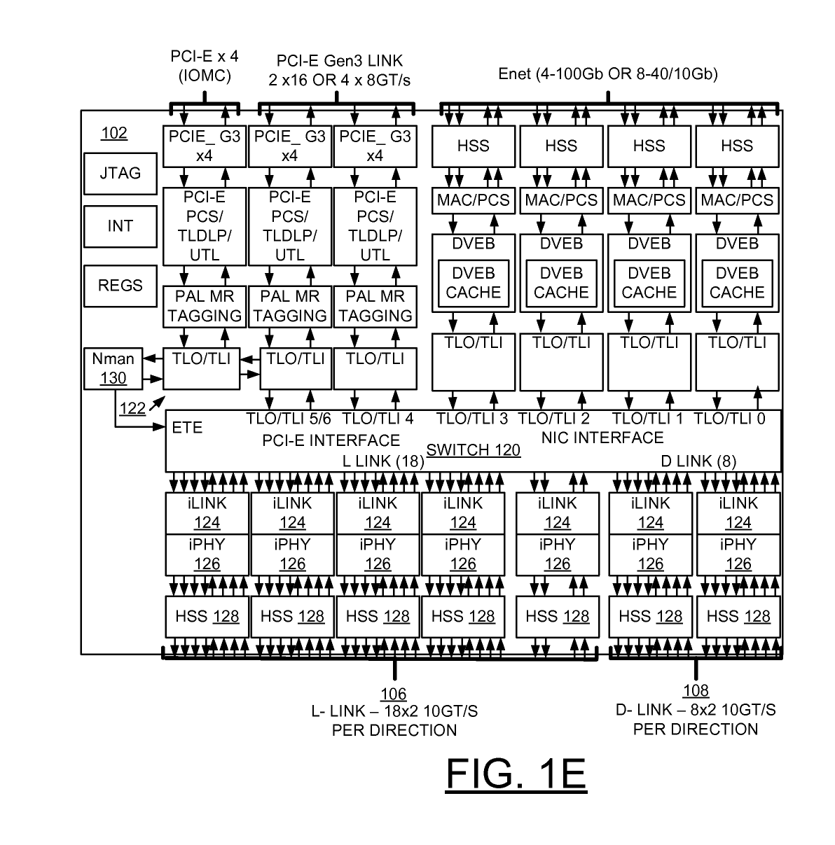

Having reference now to the drawings, in FIG. 1A, there is shown an example multiple-path local rack interconnect system generally designated by the reference character 100 used for implementing a single path for control in accordance with the preferred embodiment. The multiple-path local rack interconnect system 100 supports computer system communications between multiple servers, and enables an Input/Output (IO) adapter to be shared across multiple servers. The multiple-path local rack interconnect system 100 supports network, storage, clustering and Peripheral Component Interconnect Express (PCIe) data traffic.

The multiple-path local rack interconnect system 100 includes a plurality of interconnect chips 102 in accordance with the preferred embodiment arranged in groups or super nodes 104. Each super node 104 includes a predefined number of interconnect chips 102, such as 16 interconnect chips, arranged as a chassis pair including a first and a second chassis group 105, each including 8 interconnect chips 102. The multiple-path local rack interconnect system 100 includes, for example, a predefined maximum number of nine super nodes 104. As shown, a pair of super nodes 104 are provided within four racks or racks 0-3, and a ninth super node 104 is provided within the fifth rack or rack 4.

In FIG. 1A, the multiple-path local rack interconnect system 100 is shown in simplified form sufficient for understanding the invention, with one of a plurality of local links (L-links) 106 shown between a pair of the interconnect chips 102 within one super node 104. The multiple-path local rack interconnect system 100 includes a plurality of L-links 106 connecting together all of the interconnect chips 102 of each super node 104. A plurality of distance links (D-links) 108, or as shown eight D-links 108 connect together the example nine super nodes 104 together in the same position in each of the other chassis pairs. Each of the L-links 106 and D-links 108 comprises a bi-directional (x2) high-speed serial (HSS) link.

Referring also to FIG. 1E, each of the interconnect chips 102 of FIG. 1A includes, for example, 18 L-links 106, labeled 18 x2 10 GT/S PER DIRECTION and 8 D-links 108, labeled 8 x2 10 GT/S PER DIRECTION.

Referring also to FIGS. 1B and 1C, multiple interconnect chips 102 defining a super node 104 are shown connected together in FIG. 1B. A first or top of stack interconnect chip 102, labeled 1,1,1 is shown twice in FIG. 1B, once off to the side and once on the top of the stack. Connections are shown to the illustrated interconnect chip 102, labeled 1,1,1 positioned on the side of the super node 104 including a plurality of L-links 106 and a connection to a device 110, such as a central processor unit (CPU)/memory 110. A plurality of D links 108 or eight D-links 108 as shown in FIG. 1A, (not shown in FIG. 1B) are connected to the interconnect chips 102, such as interconnect chip 102, labeled 1,1,1 in FIG. 1B.

As shown in FIG. 1B, each of a plurality of input/output (I/O) blocks 112, is connected to respective interconnect chips 102, and respective ones of the I/O 112 are connected together. A source interconnect chip 102, such as interconnect chip 102, labeled 1,1,1 transmits or sprays all data traffic across all L-links 106. A local I/O 112 may also use a particular L-link 106 of destination I/O 112. For a destination inside a super node 104, or chassis pair of first and second chassis group 105, a source interconnect chip or an intermediate interconnect chip 102 forwards packets directly to a destination interconnect chip 102 over an L-link 106. For a destination outside a super node 104, a source interconnect chip or an intermediate interconnect chip 102 forwards packets to an interconnect chip 102 in the same position on the destination super node 104 over a D-link 108. The interconnect chip 102 in the same position on the destination super node 104 forwards packets directly to a destination interconnect chip 102 over an L-link 106.

In the multiple-path local rack interconnect system 100, the possible routing paths with the source and destination interconnect chips 102 within the same super node 104 include a single L-link 106; or a pair of L-links 106. The possible routing paths with the source and destination interconnect chips 102 within different super nodes 104 include a single D-link 108 (D); or a single D-link 108, and a single L-link 106 (D-L); or a single L-link 106, and single D-link 108 (L-D); or a single L-link 106, a single D-link 108, and a single L-link 106 (L-D-L). With an unpopulated interconnect chip 102 or a failing path, either the L-link 106 or D-link 108 at the beginning of the path is removed from a spray list at the source interconnect 102.

As shown in FIGS. 1B and 1C, a direct path is provided from the central processor unit (CPU)/memory 110 to the interconnect chips 102, such as chip 102, labeled 1,1,1 in FIG. 1B, and from any other CPU/memory connected to another respective interconnect chip 102 within the super node 104.

Referring now to FIG. 1C, a chassis view generally designated by the reference character 118 is shown with a first of a pair of interconnect chips 102 connected a central processor unit (CPU)/memory 110 and the other interconnect chip 102 connected to input/output (I/O) 112 connected by local rack fabric L-links 106, and D-links 108. Example connections shown between each of an illustrated pair of servers within the CPU/memory 110 and the first interconnect chip 102 include a Peripheral Component Interconnect Express (PCIe) G3 x8, and a pair of 100 GbE or 2-40 GbE to a respective Network Interface Card (NIC). Example connections of the other interconnect chip 102 include up to 7-40/10 GbE Uplinks, and example connections shown to the I/O 112 include a pair of PCIe G3 x 16 to an external MRIOV switch chip, with four x16 to PCI-E I/O Slots with two Ethernet slots indicated 10 GbE, and two storage slots indicated as SAS (serial attached SCSI) and FC (fibre channel), a PCIe x4 to a IOMC and 10 GbE to CNIC (FCF).

Referring now to FIGS. 1D and 1E, there are shown block diagram representations illustrating an example interconnect chip 102. The interconnect chip 102 includes an interface switch 120 connecting a plurality of transport layers (TL) 122, such as 7 TLs, and interface links (iLink) layer 124 or 26 iLinks. An interface physical layer protocol, or iPhy 126 is coupled between the interface links layer iLink 124 and high speed serial (HSS) interface 128, such as 7 HSS 128. As shown in FIG. 1E, the 7 HSS 128 are respectively connected to the illustrated 18 L-links 106, and 8 D-links 108. In the example implementation of interconnect chip 102, 26 connections including the illustrated 18 L-links 106, and 8 D-links 108 to the 7 HSS 128 are used, while the 7 HSS 128 would support 28 connections.

The TLs 122 provide reliable transport of packets, including recovering from broken chips 102 and broken links 106, 108 in the path between source and destination. For example, the interface switch 120 connects the 7 TLs 122 and the 26 iLinks 124 in a crossbar switch, providing receive buffering for iLink packets and minimal buffering for the local rack interconnect packets from the TLO 122. The packets from the TL 122 are sprayed onto multiple links by interface switch 120 to achieve higher bandwidth. The iLink layer protocol 124 handles link level flow control, error checking CRC generating and checking, and link level retransmission in the event of CRC errors. The iPhy layer protocol 126 handles training sequences, lane alignment, and scrambling and descrambling. The HSS 128, for example, are 7 x8 full duplex cores providing the illustrated 26 x2 lanes.

In FIG. 1E, a more detailed block diagram representation illustrating the example interconnect chip 102 is shown. Each of the 7 transport layers (TLs) 122 includes a transport layer out (TLO) partition and transport layer in (TLI) partition. The TLO/TLI 122 respectively receives and sends local rack interconnect packets from and to the illustrated Ethernet (Enet), and the Peripheral Component Interconnect Express (PCI-E), PCI-E x4, PCI-3 Gen3 Link respectively via network adapter or fabric adapter, as illustrated by blocks labeled high speed serial (HSS), media access control/physical coding sub-layer (MAC/PCS), distributed virtual Ethernet bridge (DVEB); and the PCIE_G3 x4, and PCIE_G3 2x8, PCIE_G3 2x8, a Peripheral Component Interconnect Express (PCIe) Physical Coding Sub-layer (PCS) Transaction Layer/Data/Link Protocol (TLDLP) Upper Transaction Layer (UTL), PCIe Application Layer (PAL MR) TAGGING to and from the interconnect switch 120. A network manager (NMan) 130 coupled to interface switch 120 uses End-to-End (ETE) small control packets for network management and control functions in multiple-path local rack interconnect system 100. The interconnect chip 102 includes JTAG, Interrupt Handler (INT), and Register partition (REGS) functions.

In accordance with features of the invention, protocol methods and transport layer circuits are provided for implementing control using a single path in accordance with the preferred embodiment. The traffic due to the internal protocols for the transport layer (TL) 122 is only a small fraction of the bandwidth of one path through the multiple-path local rack interconnect system 100. The individual paths through the network are ordered and a pair of a source TL and a destination TL use only one path to communicate control messages for the TL and have the benefit of an ordered network connection for their internal control protocols. The control messages for the TL or control TL messages include a message sent from one TL to another TL, such as, packet acknowledgement, credit negotiation, and network management.

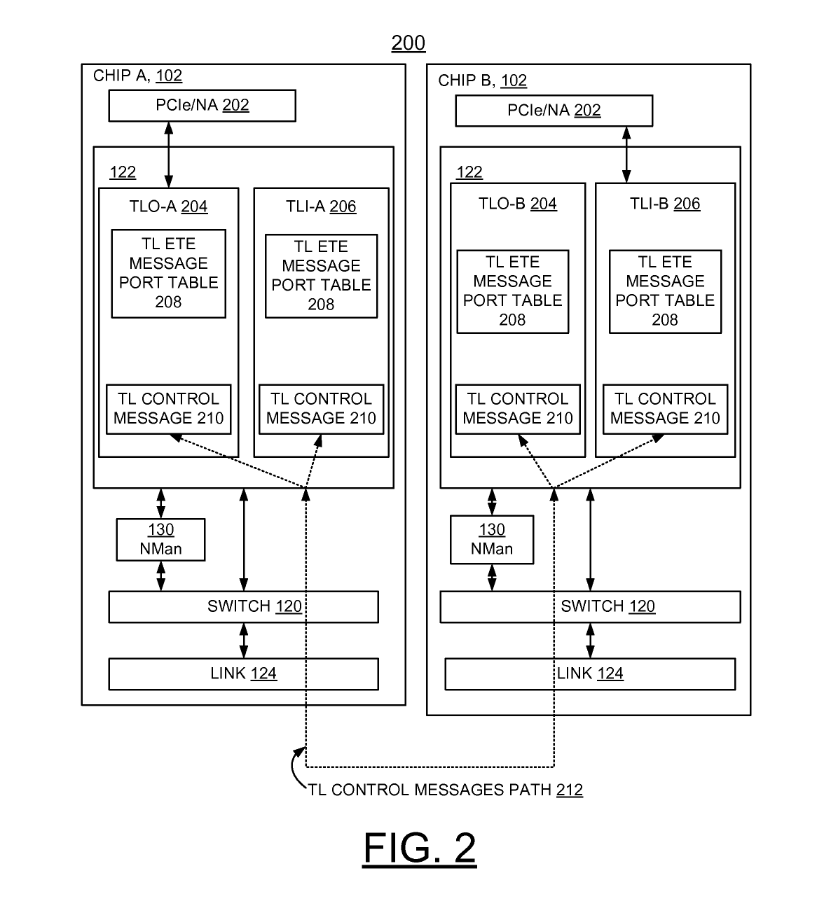

Referring now to FIG. 2, there is shown a circuit generally designated by the reference character 200 for implementing control using a single path in accordance with the preferred embodiment. Circuit 200 and each interconnect chip 102 includes a respective Peripheral Component Interconnect Express (PCIe)/Network Adapter (NA) 202 or PCIe/NA 202, as shown included in an illustrated pair of interconnect chips 102 of a source interconnect chip A, 102 and a destination interconnect chip B, 102. Circuit 200 and each interconnect chip 102 includes a transport layer (TL) 122 including a transport layer out (TLO)-A 204, TLO-B 204 and a respective transport layer in (TLI)-A, TLI-B, 206 as shown in FIG. 2.

Each TLO-A 204, TLI-A, TLO-B 204, TLI-B, 206 of each respective transport layer 122 includes a TL End-to-End (ETE) message port table 208 including a respective TL ETE message port that indicates which port that will be used to send and receive messages to and from the other TL 122. Each TLO-A 204, TLI-A, TLO-B 204, TLI-B, 206 of each respective transport layer 122 includes a TL control message block 210 using a single TL control message path 212 defined by the TL ETE message port 208. All TL ETE messages 210 sent to the other TL 122 use the TL ETE message port 208 as the source exit port. All TL ETE messages received on ports other than the designated TL message port are dropped. The TL message port is initially set to invalid. Each interconnect chip 102 includes a network manager (NMan) 130 that is coupled to interface switch 120 and the TL 122 using End-to-End (ETE) small control packets or ETE flits for network management and control functions in multiple-path local rack interconnect system 100.

In accordance with features of protocol methods and transport layer circuits of the invention, all paths for the same source and destination through the network are non-overlapping. No two paths between the same source and destination will share the same exit port at the source chip A, 102, nor the same arrival port at the destination chip B, 102, as shown in FIG. 2. All paths are symmetric. In other words if a path exists that starts at TLO-A 204 using source-chip-exit-port ‘B’ and arrives at destination-chip-arrival-port ‘C’ for TLI-B 206; then a path also exist that: starts at TLO-B 204 using source-chip-exit-port ‘C’ and arrives at destination-chip-arrival-port ‘B’ for TLI-A 206.

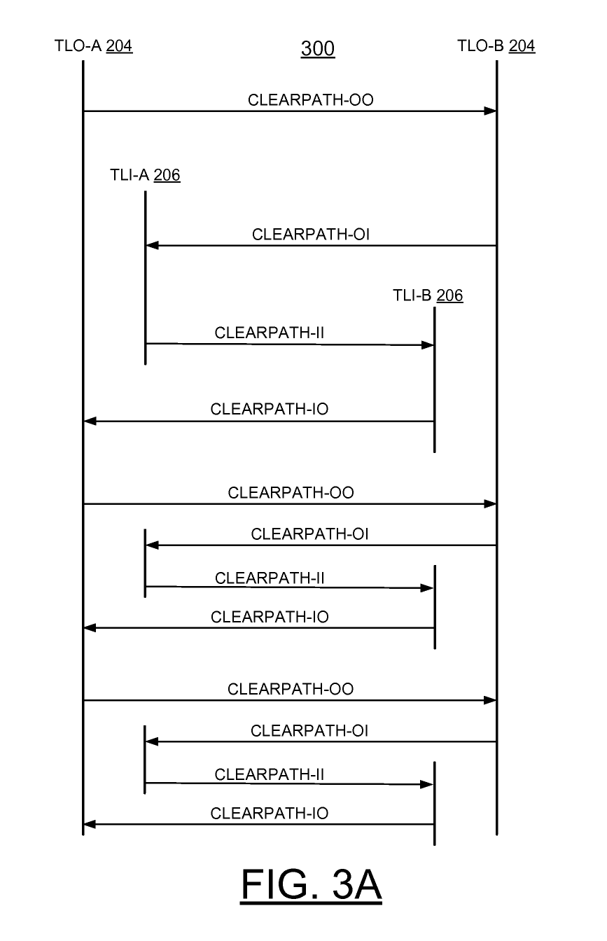

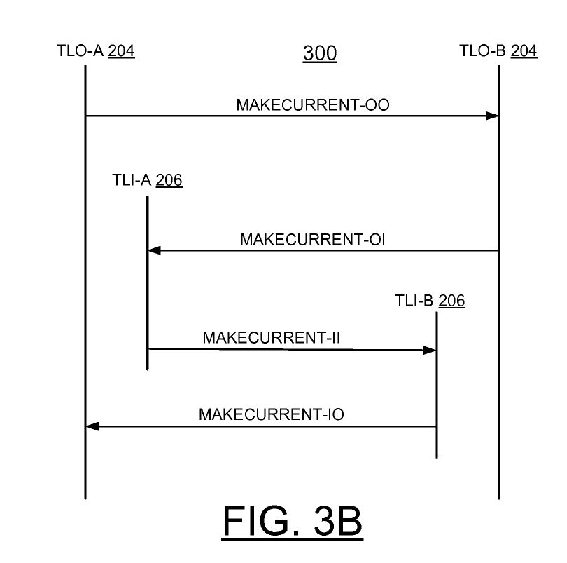

In accordance with features of protocol methods and transport layer circuits of the invention, the link layer 124 and switch layer 120 keep TL messages in order for messages that have the same source and same destination, and the same TL control message path 212, and transfers the TL messages in an ordered control message stream. A predefined TL protocol as illustrated in FIGS. 3A, 3B, 4, and 5 is used for negotiating and controlling the TL control message path 212 used for the TL control messages:

In accordance with features of protocol methods and transport layer circuits of the invention, each pair of TLs 122 that are communicating with each other, each of TLs 122 are kept up to date with respect to which paths to the other destination TL that are actually working along with the hop-count for each path. Paths are identified by their source-node-exit-port.

Referring to FIGS. 3A and 3B, there are shown exemplary operations generally designated by the reference character 300 performed by the circuit 200 for implementing control using a single TL control message path 212. When NMan 130 indicates that the current TL message port 208 is not a valid working path or the path 212 is not shortest working path then the TL message port is changed according to the illustrated protocol of FIGS. 3A and 3B: The TL 122 with the lowest ID is the master in this exchange, the other TL is the slave.

As indicated by the line CLEARPATH-OO from TLO-A 204 to TLO-B, 204, the master TLO-A 204 of chip A, 102 chooses the best port from among the working paths to the slave TL and designates the pending TL message port. The master TLO-A 204 sends a Clearpath-OO TL message 210 to the slave TLO-B 204 using the pending TL message port. The Clearpath-OO message contains a random key, for example, 5 bits, to distinguish it from old Clearpath messages that may still be on this path. When the slave TLO-B 204 receives this message, it sets its pending TL message port to the port that received the Clearpath-OO TL message. Clearpath-OO messages are not checked against the TL message port 208.

In response to the Clearpath-OO TL message, as indicated by the line CLEARPATH-OI from TLO-B 204 to TLI-A, 206, the slave TLO-B 204 sends a Clearpath-OI TL message 210 back to the master TLI-A, 206 using the pending TL message port. The Clearpath-OI TL message contains the key from the received Clearpath-OO TL message. When the master TLI-A, 206 receives the Clearpath-OI TL message, it sets its the pending TL message port to the port that that received the Clearpath-OI TL message. Clearpath-OI TL messages are not checked against the TL message port 208.

In response to the Clearpath-OI TL message, as indicated by the line CLEARPATH-II from TLI-A 206 to TLI-B, 206, the master TLI-A 206 of chip A, 102 sends a Clearpath-II TL message 210 to the slave TLI-B 206 using the pending TL message port. The Clearpath-II TL message 210 contains the key from the received Clearpath-OI TL message. In response to the Clearpath-II TL message, as indicated by the line CLEARPATH-IO from TLI-B 206 to TLO-A, 204, the slave TLI-B 206 sets its pending TL message port to the port that that received the Clearpath-II TL message and sends a Clearpath-IO TL message 210 back to the master TLO-A, 204 using the pending TL message port.

When the master TLO-A, 204 receives Clearpath-IO TL message 210, Clearpath-IO TL messages are not checked against the TL message port. The master TL verifies that the Clearpath-IO TL message 210 was received on the pending TL message port. The master TL verifies that the Clearpath-IO TL message 210 contains the same key as was sent in the CLEARPATH-OO TL message. If either of these two checks fail, the Clearpath-IO TL message 210 is ignored.

If the master TLO-A, 204 times out waiting for the Clearpath-IO TL message the master TLO-A, 204 starts over, indicated by the line CLEARPATH-OO from TLO-A 204 to TLO-B, 204, the master TLO-A, 204 of chip A, 102 again chooses a best port and can choose the same best port as the last time from among the working paths to the slave TLO-B, 204 and designates that the pending TL message port. The master TLO-A, 204 sends the Clearpath-OO TL message 210 to the slave TLO-B, 204 using the pending TL message port, and the operations are repeated.

These steps can be done a number of times to build confidence that the Clearpath packets are not from previous attempts. Because TL messages 210 are kept in-order by the link 124 and-switch layer 120, once the Clearpath-OO/OI/II/IO sequence has been completed we know that no old TL messages 210 exist in the new path 212.

Referring to FIG. 3B, as indicated by the line MAKECURRENT-OO from TLO-A 204 to TLO-B, 204, the master TLO-A 204 of chip A, 102 sends a MakeCurrent-OO TL message 210 to the slave TLO-B 204 using the pending TL message port. The MakeCurrent-OO TL message 210 contains a random key, for example 5 bits, to distinguish it from old MakeCurrent-OO TL messages that may still be on this path. The slave TLO-B 204 receives the MakeCurrent-OO message 210. If the MakeCurrent-OO message 210 was received on the pending TL message port, the slave TLO-B, 204 sets the TL message port to the received port. If the MakeCurrent-OO TL message 210 was received on the pending TL message port, the slave TLO-B, 204 sends a MakeCurrent-OI message on the same port to the master TLI-A, 206 including the key from the MakeCurrent-OO message as indicated by the line MAKECURRENT-OI from TLO-B 204 to TLI-A, 206. Otherwise, the slave TLO-B, 204 drops the MakeCurrent-OO TL message 210.

The master TLI-A 206 receives the MakeCurrent-OI TL message 210. If the MakeCurrent-OI message 210 was received on the pending TL message port, the master TLI-A 206 sets the TL message port to the received port. If the MakeCurrent-OI TL message 210 was received on the pending TL message port, the master TLI-A 206 sends a MakeCurrent-II message on the same port to the slave TLI-B, 206 including the key from the MakeCurrent-OI message as indicated by the line MAKECURRENT-II from TLI-A 206 to TLI-B, 206. Otherwise, the master TLI-A 206 drops the MakeCurrent-OI TL message 210.

The TLI-B, 206 of slave TL 122 receives the MakeCurrent-II message 210. If the MakeCurrent-II message 210 was received on the pending TL message port, the slave TLI-B, 204 sets the TL message port to the received port. If the MakeCurrent-II TL message 210 was received on the pending TL message port, the slave TLI-B, 204 sends a MakeCurrent-IO message on the same port to the master TLO-A, 206 including the key from the MakeCurrent-II message as indicated by the line MAKECURRENT-IO from TLI-B 206 to TLO-A, 204. Otherwise, the slave TLI-B, 206 drops the MakeCurrent-II TL message 210.

The master TLO-A 204 receives the MakeCurrent-IO TL message 210. If the MakeCurrent-IO message 210 was received on the pending TL message port and contains the key originally sent in the MakeCurrent-OO TL message, then the master TLO-A 204 sets the TL message port 208 to the received port, and then the protocol is finished. Otherwise, the master TLO-A 204 drops the MakeCurrent-IO TL message 210.

At this point, TL messages 210 can now flow over the new path 212. Intermediate messages might have been dropped while the path 212 was switched, but no two messages received by the destination will ever be reordered with respect to one another. The other TL message protocols, such as acknowledgements, credit negotiation, and the like are now built assuming that TL messages will not be reordered.

If the master TLO-A 204 times out waiting for the MakeCurrent-IO TL message the master TLO-A 204 starts over, indicated in FIG. 3A by the line CLEARPATH-OO from TLO-A 204 to TLO-B, 204, the master TLO-A 204 of chip A, 102 chooses another best port or can choose the same best port as the last time from among the working paths to the slave TL and designates that the pending TL message port. The master TLO-A 204 sends a Clearpath-OO TL message 210 to the slave TLO-B 204 using the pending TL message port, and the operations are repeated.

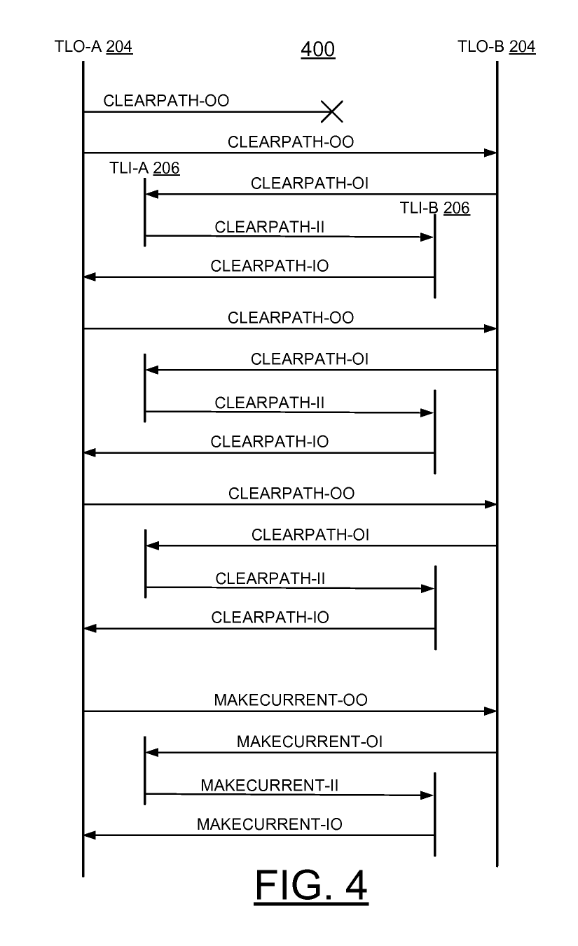

Referring to FIG. 4, there are shown exemplary operations generally designated by the reference character 400 performed by the circuit 200 for implementing control using a single TL control message path 212. As shown in FIG. 4, an error occurs when the Clearpath-OO TL message is sent and a Clearpath-OI TL message is not received.

As indicated by the line CLEARPATH-OO from TLO-A 204, the TLO-A, 204 of the master TLO-A 204 of chip A, 102 sends a Clearpath-OO TL message 210 using the pending TL message port and the Clearpath TL message 210 is dropped by the local rack interconnect 100, and thus is not received by the slave TLO-B 204. The TLO-A, 204 times out waiting for the Clearpath-IO TL message 210 from the TLI-B 206.

The TLO-A, 204 of chip A, 102 sends the Clearpath-OO TL message 210 using the same pending TL message port and the Clearpath TL message 210 is received by the slave TLO-B, 204. Then the operations continue as described and shown with respect to FIGS. 3A, and 3B.

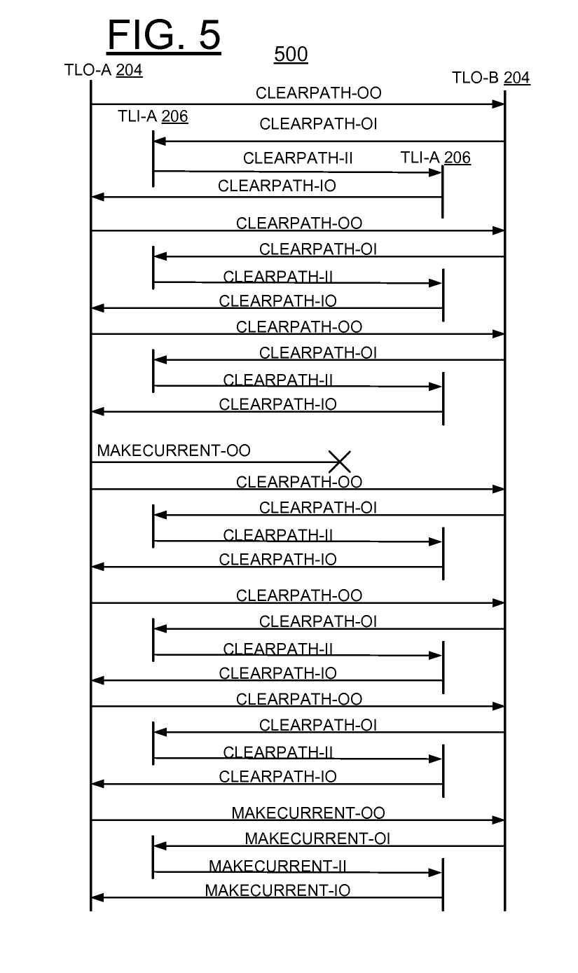

Referring to FIG. 5, there are shown exemplary operations generally designated by the reference character 500 performed by the circuit 200 for implementing control using a single TL control message path 212. As shown in FIG. 5, an error occurs when a MakeCurrent-OO is sent.

First, the Clearpath TL message protocol sequence is completed without error, as illustrated and described with respect to FIGS. 3A, and 3B in the exemplary operations 500 of FIG. 5.

As indicated by the line MAKECURRENT-OO from TLO-A 204, the master TLO-A, 204 sends a MakeCurrent-OO TL message 210 using the pending TL message port and the MakeCurrent-OO TL message 210 is dropped by the local rack interconnect 100, and thus is not received by the slave TLO-B, 204. The TLO-A, 204 times out waiting for the MakeCurrent-IO TL message 210 from the TLI-B 206.

Then the TLO-A, 204 of the master TL 122 of chip A, 102 starts over, sending the Clearpath-OO TL message 210 using the same pending TL message port and the Clearpath-OO TL message 210 is received by the slave TLO-B 204. Then the operations continue and are completed without error, the same as described and shown with respect to FIGS. 3A, and 3B.

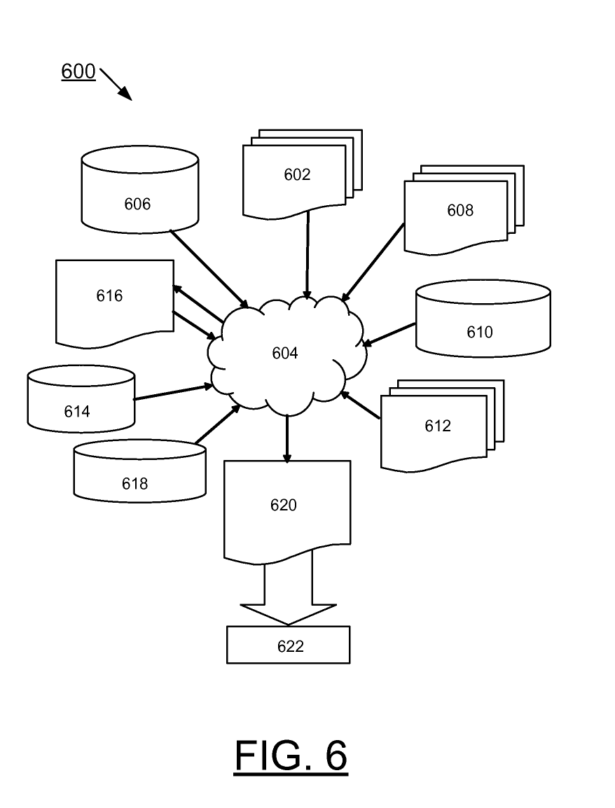

FIG. 6 shows a block diagram of an example design flow 600 that may be used for circuit 200 and the interconnect chip 102 described herein. Design flow 600 may vary depending on the type of IC being designed. For example, a design flow 600 for building an application specific IC (ASIC) may differ from a design flow 600 for designing a standard component. Design structure 602 is preferably an input to a design process 604 and may come from an IP provider, a core developer, or other design company or may be generated by the operator of the design flow, or from other sources. Design structure 602 comprises circuits 102, 200 in the form of schematics or HDL, a hardware-description language, for example, Verilog, VHDL, C, and the like. Design structure 602 may be contained on one or more machine readable medium. For example, design structure 602 may be a text file or a graphical representation of circuits 102, 200. Design process 604 preferably synthesizes, or translates, circuits 102, 200 into a netlist 606, where netlist 606 is, for example, a list of wires, transistors, logic gates, control circuits, I/O, models, etc. that describes the connections to other elements and circuits in an integrated circuit design and recorded on at least one of machine readable medium. This may be an iterative process in which netlist 606 is resynthesized one or more times depending on design specifications and parameters for the circuits.

Design process 604 may include using a variety of inputs; for example, inputs from library elements 608 which may house a set of commonly used elements, circuits, and devices, including models, layouts, and symbolic representations, for a given manufacturing technology, such as different technology nodes, 32 nm, 45 nm, 90 nm, and the like, design specifications 610, characterization data 612, verification data 614, design rules 616, and test data files 618, which may include test patterns and other testing information. Design process 604 may further include, for example, standard circuit design processes such as timing analysis, verification, design rule checking, place and route operations, and the like. One of ordinary skill in the art of integrated circuit design can appreciate the extent of possible electronic design automation tools and applications used in design process 604 without deviating from the scope and spirit of the invention. The design structure of the invention is not limited to any specific design flow.

Design process 604 preferably translates an embodiment of the invention as shown in FIGS. 1A-1E, 2, 3A, 3B, 4, and 5 along with any additional integrated circuit design or data (if applicable), into a second design structure 620. Design structure 620 resides on a storage medium in a data format used for the exchange of layout data of integrated circuits, for example, information stored in a GDSII (GDS2), GL1, OASIS, or any other suitable format for storing such design structures. Design structure 620 may comprise information such as, for example, test data files, design content files, manufacturing data, layout parameters, wires, levels of metal, vias, shapes, data for routing through the manufacturing line, and any other data required by a semiconductor manufacturer to produce an embodiment of the invention as shown in FIGS. 1A-1E, 2, 3A, 3B, 4, and 5. Design structure 620 may then proceed to a stage 622 where, for example, design structure 620 proceeds to tape-out, is released to manufacturing, is released to a mask house, is sent to another design house, is sent back to the customer, and the like.

While the present invention has been described with reference to the details of the embodiments of the invention shown in the drawing, these details are not intended to limit the scope of the invention as claimed in the appended claims.

What is claimed is:

1. A method for implementing control using a single path in a multiple path interconnect system comprising:
providing a transport layer (TL) with each source interconnect chip and each destination interconnect chip;
providing a control TL message to transfer control information between a respective pair of a source transport layer (TL) with a source interconnect chip and a destination transport layer (TL) of a destination interconnect chip; and
providing a respective TL message port identifying a port used to send and receive the control TL message for said source TL and said destination TL; said respective TL message port defining the single path.

2. The method as recited in claim 1 includes providing a respective switch and link layer coupled to said transport layer; said respective switch and link layer identifying a control TL messages having a same source TL, a same destination TL, and a same path, and transferring the identified control TL messages in an ordered control stream.

3. The method as recited in claim 1 wherein providing said respective TL message port identifying a port used to send and receive the control TL message for said source TL and said destination TL includes using a predefined protocol message sequence to identify a new TL message port.

4. The method as recited in claim 3 wherein using a predefined protocol message sequence to identify a new TL message port includes identifying one of the source TL or the destination TL having a lowest ID as a master TL and the other as a slave TL for the predefined protocol message sequence.

5. The method as recited in claim 4 wherein using a predefined protocol message sequence to identify a new TL message port includes the master TL selecting a pending TL message port and sending control messages to the slave TL using the pending TL message port.

6. The method as recited in claim 5 wherein using a predefined protocol message sequence to identify a new TL message port includes the slave TL sending control acknowledgement messages to the master TL using the pending TL message port.

7. The method as recited in claim 6 wherein using a predefined protocol message sequence to identify a new TL message port includes completing the predefined protocol message sequence, setting the pending TL message port to the TL message port for the pair of source TL and destination TL.

8. A circuit for implementing control using a single path in a multiple path interconnect system comprising:
a source interconnect chip coupled to a source device; said source interconnect chip including a source transport layer (TL);
a destination interconnect chip coupled to the destination device; said destination interconnect chip including a destination transport layer (TL);
each of said source TL and said destination TL including a respective TL message port used to send and receive a control TL message between a respective pair of said source TL and said destination TL; said respective TL message port defining the single path for control messages.

9. The circuit as recited in claim 8 wherein said source interconnect chip and said destination interconnect chip includes a respective switch and link layer coupled to said respective source TL and said destination TL; said respective switch and link layer identifying control TL messages having a same source TL, a same destination TL, and a same path, and transferring the identified control TL messages in an ordered control message stream.

10. The circuit as recited in claim 8 wherein said source TL and said destination TL use a predefined protocol message sequence to identify a new TL message port.

11. The circuit as recited in claim 10 wherein said predefined protocol message sequence includes said source TL and said destination TL identifying a master TL and a slave TL, said master TL selecting a pending TL message port and sending control messages to said slave TL using the pending TL message port.

12. The circuit as recited in claim 11 wherein said predefined protocol message sequence includes said slave TL sending control acknowledgement messages to said master TL using the pending TL message port.

13. The circuit as recited in claim 10 wherein said predefined protocol message sequence includes said source TL and said destination TL setting the new TL message port to said TL message port for the pair of said source TL and said destination TL, responsive to completing the predefined protocol message sequence.

14. A multiple-path local rack interconnect system comprising:
a plurality of interconnect chips including a source interconnect chip coupled to a source device and a destination interconnect chip coupled to the destination device;
a plurality of serial links connected between each of said plurality of interconnect chips;
said source interconnect chip including a source transport layer (TL);
said destination interconnect chip including a destination transport layer (TL);
each of said source TL and said destination TL including a respective TL message port used to send and receive a control TL message between a respective pair of said source TL and said destination TL; said respective TL message port defining a single path for control messages.

15. The multiple-path local rack interconnect system as recited in claim 14 wherein said source interconnect chip and said destination interconnect chip includes a respective switch and link layer coupled to said respective source TL and said destination TL; said respective switch and link layer identifying control TL messages having a same source TL, a same destination TL, and a same path, and transferring the identified control TL messages in an ordered control message stream.

16. The multiple-path local rack interconnect system as recited in claim 14 wherein said source TL and said destination TL use a predefined protocol message sequence to identify a new TL message port.

17. A design structure embodied in a machine readable medium used in a design process, the design structure comprising:
a circuit tangibly embodied in the machine readable medium used in the design process, said circuit for implementing control using a single path in a multiple path interconnect system, said circuit comprising:
a source interconnect chip coupled to a source device; said source interconnect chip including a source transport layer (TL);
a destination interconnect chip coupled to the destination device; said destination interconnect chip including a destination transport layer (TL);
each of said source TL and said destination TL including a respective TL message port used to send and receive a control TL message between a respective pair of said source TL and said destination TL; said respective TL message port defining the single path for control messages, wherein the design structure, when read and used in the manufacture of a semiconductor chip produces a chip comprising said circuit.

18. The design structure of claim 17, wherein the design structure comprises a netlist, which describes said circuit.

19. The design structure of claim 17, wherein the design structure resides on storage medium as a data format used for the exchange of layout data of integrated circuits.

20. The design structure of claim 17, wherein the design structure includes at least one of test data files, characterization data, verification data, or design specifications.
